(19) United States
(12) Patent Application Publication
(10) Pub. No.: US 2022/0217119 A1
(43) Pub. Date: Jul. 7, 2022

(54) METHOD FOR INDICATING A USE OF AN ILLICIT IP ADDRESS

(71) Applicant: SAGEMCOM BROADBAND SAS, Rueil-Malmaison (FR)

(72) Inventors: Hatim FADLE, Rueil Malmaison (FR); Laurent ALARCON, Rueil Malmaison (FR)

(73) Assignee: SAGEMCOM BROADBAND SAS, Rueil-Malmaison (FR)

(21) Appl. No.: 17/569,116

(22) Filed: Jan. 5, 2022

(30) Foreign Application Priority Data
Jan. 7, 2021 (FR) 2100105

(51) Int. Cl. H04L 9/40; H04L 101/659; H04L 61/5046; H04L 45/745

(52) U.S. Cl. CPC H04L 63/0236; H04L 63/126; H04L 45/745; H04L 61/2046; H04L 61/6059

(57) ABSTRACT

A method for indicating a use of an illicit IP address in a local communication network connected to a wide area communication network by a router, the method including: receiving a packet from at least one device in the local communication network using an illicit IP address; generating an error message marked with a predefined mark; sending the marked error message to the at least one device using an additional routing table redirecting each packet to the local communication network and a routing rule applying the additional routing table to each packet marked with the predefined mark.

### TECHNICAL FIELD

The present invention relates to the field of routing messages between communication networks and more precisely the routing of messages sent by a device that is using an illicit, i.e. invalid, IP address in a communication network.

### PRIOR ART

A local communication network can communicate with a wide area communication network by means of a router, making it possible to interconnect the two networks, and by sharing the same protocol, such as for example the IP protocol (“Internet Protocol”). An IP address must thus be attributed to each device in the local area network for said device to be able to communicate with the wide area network. IP addresses can be attributed in accordance with various procedures such as the RFC 4862 procedure (RFC standing for “Request For Comments”) or the RFC 8415 procedure, wherein the router or a DHCP (“Dynamic Host Configuration Protocol”) server attributes all or part of an IP address to a device of the local communication network that made an IP address request.

However, it happens that an IP address used by a device may be illicit, i.e. invalid, since it is not recognised by the router. The IP address is then considered to be illicit. For example, an IP address is sometimes attributed to a device with a lease, in other words with a length of life after which the device must request a renewal of the IP address. When the device does not make such a request for renewing its IP address, the IP address expires and is then no longer recognised by the router. According to another example, the router may send a notification for modifying an IP address or an IP address prefix attributed to a device. However, if the notification is not taken into account by said device, the device continues to use an old IP address that has become illicit. In some cases, the IP address of a device is attributed manually and may prove to be erroneous.

A device using an illicit IP address cannot easily be informed of the invalidity of its IP address since it is not possible to use said illicit IP address for communicating with said device. Furthermore, the use of an illicit IP address by a device may generate cumbersome and unnecessary traffic on the wide area network.

It is therefore desirable to overcome these drawbacks of the prior art. It is in particular desirable to provide a solution that makes it possible to indicate to a device a use of an illicit IP address. It is furthermore desirable to propose a solution for correcting an illicit IP address used by a device. It is moreover desirable to propose a solution that makes it possible to avoid cluttering the local communication network and the wide area communication network with data sent by a device using an illicit IP address.

### DISCLOSURE OF THE INVENTION

One object of the present invention is to propose a method for indicating a use of an illicit IP address in a local communication network, the local communication network being connected to another communication network by means of a router. The method comprises the steps, performed by the router, of: receiving a packet from at least one device belonging to said local communication network, said received packet comprising an illicit source IP address; generating an error message packet and marking said error message packet with a predefined mark; and returning the marked error message packet to said at least one device using an additional routing table redirecting each packet to the local communication network and a routing rule applying said additional routing table to each packet marked with said predefined mark.

Thus it is possible to indicate the use of an illicit IP address to the device using an illicit IP address by sending an error message to it. The device using an illicit IP address can then react to the reception of said error message in order to request a reattribution or a modification of its IP address. Furthermore, sending an error message to the illicit IP address is prevented, which avoids cluttering the other network.

According to a particular embodiment, the method further comprises marking the packet received with said predefined mark and rejecting the packet received.

According to a particular embodiment, the method further comprises: recording in a table, referred to as an illicit IP address table, an identifier of the device using said illicit source IP address, in association with a received-packet counter initialised to an initial value, and in association with a time of reception of said received packet, referred to as a first reception time, if said identifier is absent from the table of illicit IP addresses; and updating the table of illicit IP addresses if the identifier of said device is present in the table of illicit IP addresses.

According to a particular embodiment, a first period being defined with a first predefined duration, said first period being counted as from the time of first reception, a second period being defined with a second predefined duration, said second predefined duration being shorter than the first predefined duration and terminating at the same time as the first period, updating the table of illicit IP addresses comprises incrementing the received-packet counter for each packet received during the second period if a time of disconnection of said device is not given in the table of illicit IP addresses.

According to a particular embodiment, a first period being defined with a first predefined duration, said first period being counted as from a time of disconnection of said device, a second period being defined with a second predefined duration, said second predefined duration being shorter than the first predefined duration and terminating at the same time as the first period, updating the table of illicit IP addresses comprises incrementing the received-packet counter for each packet received during the second period, if said time of disconnection of said device is given in the table of illicit IP addresses.

According to a particular embodiment, the method further comprises the step of deleting the identifier from the table of illicit IP addresses in the case where the first period has elapsed and the received-packet counter is equal to said initial value.

According to a particular embodiment, the method furthermore comprises the step of forcing the device to reinitialise its network interface by disconnecting it from said local communication network, recording the time of disconnection in said table of illicit IP addresses and reinitialising said received-packet counter to the initial value, in the case where the first period has elapsed and the received-packet counter is different from said initial value.

Thus it is possible to identify whether a device using an illicit IP address remedies by itself the use of said illicit IP address or persists in using said illicit IP address. It is furthermore possible to force a device that persists in using an illicit IP address to request a reattribution or to make a modification of its IP address during a reinitialisation of its network interface. According to a particular embodiment, the method further comprises: preventing, during a configured quarantine duration, any communication with said device when the first period has elapsed, if a time of disconnection of a network interface of said device is given in said table, and if the received-packet counter is different from the initial value.

According to a particular embodiment, the configured quarantine duration increases at each new quarantine, a quarantine being a period during which any communication with the device is prevented.

According to a particular embodiment, the quarantine duration is equal to n*Dt where n is a number of quarantines and Dt is an initial quarantine duration.

According to a particular embodiment, the quarantine duration is equal to 2⁽ⁿ⁻¹⁾*Dt where n is a number of quarantines and Dt is an initial quarantine duration.

According to a particular embodiment, the first communication network and the other communication network use the IPv6 communication protocol.

Thus, when a device persists in using an illicit IP address, even after having been forced to reinitialise its network interface, it is possible to prevent a cluttering of the local communication network because of packets sent by said device and error messages sent.

The invention also relates to a router connecting a local communication network to another communication network. The router comprises: means for receiving a packet from at least one device belonging to said local communication network, said received packet comprising an illicit source IP address; means for generating an error message packet and for marking said error message packet with a predefined mark; and means for returning the marked error message packet to said at least one device using an additional routing table redirecting each packet to the local communication network and a routing rule applying said additional routing table to each packet marked with said predefined mark.

According to a particular embodiment, the router further comprises: means for recording in a table, referred to as an illicit IP address table, an identifier of the device using said illicit source IP address; in association with a received-packet counter initialised to an initial value, and in association with a time of reception of said received packet, referred to as the time of first reception, if said identifier is absent from the table of illicit IP addresses. The router further comprises means for updating the table of illicit IP addresses, if the identifier of said device is present in the table of illicit IP addresses.

According to a particular embodiment, said means for updating the table of illicit IP addresses comprise means for incrementing the received-packet counter for each packet received during a second period if a time of disconnection of said device is not given in the table of illicit IP addresses, a first period being defined with a first predefined duration, the first period being counted as from the time of first reception, the second period being defined with a second predefined duration, the second predefined duration being shorter than the first predefined duration and terminating at the same time as the first period. According to a particular embodiment, said means for updating the table of illicit IP addresses comprise means for incrementing the received-packet counter for each packet received during a second period, if said time of disconnection of said device is given in the table of illicit IP addresses, a first period being defined with a first predefined duration, the first period being counted as from a time of disconnection of said device, the second period being defined with a second predefined duration, the second predefined duration being shorter than the first predefined duration and terminating at the same time as the first period.

According to a particular embodiment, the router further comprises means for deleting the identifier from the table of illicit IP addresses in the case where the first period has elapsed and the received-packet counter is equal to said initial value.

According to a particular embodiment, the router further comprises means for forcing the device to reinitialise its network interface by disconnecting it from said local communication network, recording the time of disconnection in said table of illicit IP addresses and reinitialising said received-packet counter to the initial value, in the case where the first period has elapsed and the received-packet counter is different from said initial value.

The invention also relates to a computer program that can be stored on a medium and/or downloaded from a communication network, in order to be read by a processor. This computer program comprises instructions for implementing the method mentioned above in any one of the embodiments thereof, when said program is executed by the processor. The invention also relates to an information storage medium storing such a computer program.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically a local communication network connected to a wide area communication network by means of a router, according to one embodiment;

FIG. 2 illustrates schematically a method for indicating a use of an illicit IP address in the local communication network, according to one embodiment;

FIG. 3 illustrates schematically a method for identifying a device that persists in using an illicit IP address in the local communication network, according to one embodiment;

FIG. 4 illustrates schematically a decision method for incrementing a counter implemented in the method for identifying a device persisting in using an illicit IP address in the local communication network, according to one embodiment;

FIG. 5 illustrates schematically a method for correcting a use of an illicit IP address in the local communication network, according to one embodiment;

FIG. 6 illustrates schematically a quarantining method implemented in the method for correcting a use of an illicit IP address in the local communication network, according to one embodiment;

FIG. 7 illustrates schematically a hardware architecture of the router implementing the method for indicating a use of an illicit IP address in the local communication network, according to one embodiment.

### DETAILED DISCLOSURE OF EMBODIMENTS

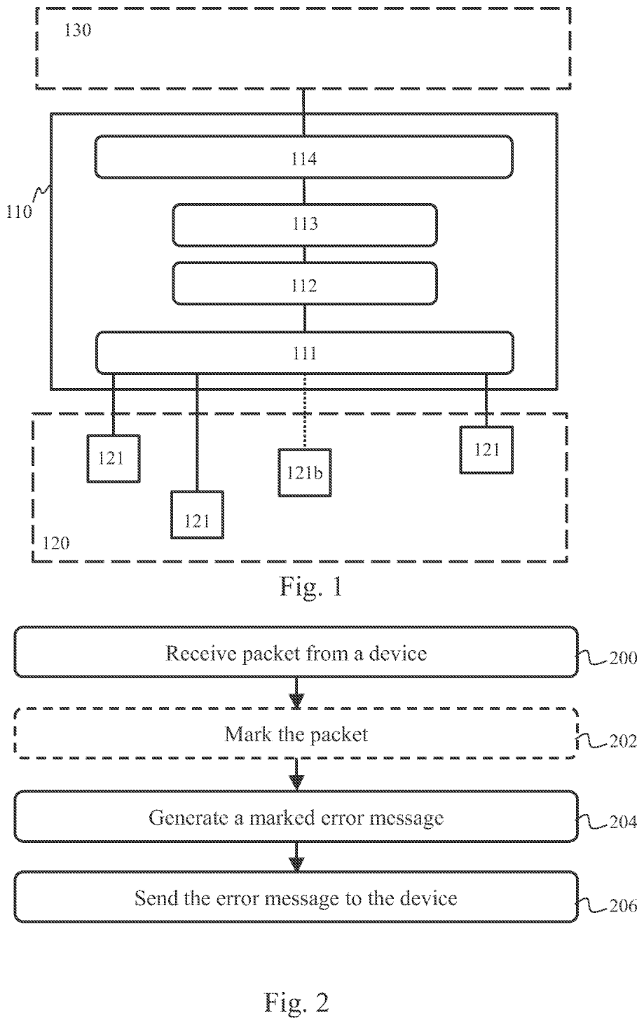

FIG. 1 illustrates schematically a local communication network, referred to as a local area network 120, connected to a wide area communication network, referred to as a wide area network 130, by means of a router 110, according to a particular embodiment.

The router 110 comprises a firewall 112 and a routing module 113. The router 110 further comprises a first interface 111 for connecting the router 110 to the local network 120 as well as a second interface 114 for connecting the router 110 to the wide area network 130. The role of the routing module 113 is to route or direct a packet received by the router 110 according to the destination IP address of said packet. The routing module 113 comprises a main routing table and may further comprise one or more additional routing tables. Each routing table comprises one or more routes that indicate to which interface 111, 114 a packet must be directed according to the destination IP address of said packet. The routing module 113 further comprises at least one routing rule that defines which routing table to use for routing a packet received by the router 110, according to predefined criteria. According to a particular embodiment, the routing module 113 comprises a main routing table comprising two routes. A first route directs each packet the destination IP address of which is recognised as belonging to the local area network 120, to the first interface 111 from which it is sent to the local area network 120, and a second route by default directs each packet the destination IP address of which does not belong to the local area network 120 to the second interface 114, from which it is sent to the wide area network 130.

The routing module 113 also comprises an additional routing table comprising a single route described below in relation to FIG. 2 and which directs each packet to the first interface 111, from which it is sent to the local area network 120.

The routing module 113 also comprises a first routing rule that applies the main routing table to each packet received, with the exception of the packets to which a second routing rule described hereinafter in relation to FIG. 2 relates.

The router 110 also comprises a firewall 112. The firewall 112 implements filtering rules that make it possible to select certain packets received from the local area network 120 or sent to the local area network 120 according to criteria such as the destination IP address or the source IP address of said packet. The destination IP address of a packet is the IP address that the packet must reach while the source IP address of a packet corresponds to the IP address of a terminal that sent said packet. A terminal corresponds for example to a terminal accessible via the wide area network 130 or to a device 121 belonging to the local area network 120. The filtering rules also make it possible to perform actions on a selected packet. A first possible action is to accept a packet, which comprises routing said packet to its destination IP address. A second action is to reject a packet, which comprises not routing said packet and furthermore sending an error message to the source IP address, in other words addressed to the device 121 that sent said packet. A third action is silently abandoning or rejecting a packet, which comprises deleting said packet without routing it and not sending an error message. A fourth action is recording a trace of a packet, in a log for example.

The local area network 120 or LAN network comprises at least one device 121 connected to the router 110 by the first interface 111. Each device 121 can communicate in the local area network 120 by exchanging data with the first interface 111 at the link layer of the OSI (Open Systems Interconnection) model. For example, a device 121 communicates with the first interface 111 by means of an Ethernet protocol, a network switch or a Wi-Fi wireless communication protocol. When the local area network 120 comprises various segments using for example various technologies, the first interface 111 is a network bridge making it possible to interconnect distinct segments of the local area network 120. According to an example embodiment, the wide area network 130 is a WAN network such as the internet. According to another example, the local area network 120 is a subnetwork of another wider network, a so-called wide area network 130.

The local area network 120 and the wide area network 130 can communicate with each other by exchanging data, in the form of packets, at the network layer of the OSI model by virtue of the use of a common protocol such as the IP protocol (Internet Protocol). The IPv6 protocol (Version 6 of the Internet Protocol) is advantageously used. An IP address must therefore be attributed to each device 121 of the local area network 120 for said device 121 to be able to communicate with the wide area network 130.

The IP address of a device 121 can be attributed in various ways. For example, according to a first procedure specific to the IPv6 protocol called RFC 4862 (RFC standing for “Request For Comments”), the IP address of a device 121 is, after said device 121 is addressed, attributed by the router 110, which offers an IP address prefix. The device 121 next chooses an IP address suffix that is not already used in the local area network 120 to construct an IP address. According to a second procedure specific to the IPv6 protocol called RFC 8415, the device 121 addresses a DHCP (Dynamic Host Configuration Protocol) server, the DHCP server in return offers an IP address to the device 121 and, when the IP address is accepted by the device 121, the DHCP server assigns said IP address with a lease with a defined lifetime. To keep said IP address beyond the lifetime, the device 121 must renew its lease periodically. Alternatively, the IP address of a device 121 is sometimes attributed manually.

When a device 121b uses an illicit IP address, in other words an IP address that is invalid since it has expired or is unknown to the router 110, said IP address is not recognised by the router 110 and cannot therefore be used for communicating with said device 121b. This may occur when a manually attributed IP address is erroneous or when the lifetime of the IP address attributed has expired. For example, this occurs if the device 121b does not renew its lease in the context of the RFC 8415 procedure. According to another example, in the context of the RFC 4862 procedure, the router 110 may send a message to the device 121b to modify the prefix of its IP address by assigning a zero lifetime to the previously attributed prefix. However, it sometimes happens that the message in question is not taken into account by the device 121b, which continues to use an old IP address that has expired or has become illicit.

FIG. 2 illustrates schematically a method for signalling a use of an illicit IP address in the local area network 120 according to one embodiment. The signalling method is implemented by the router 110.

In a step 200, the router 110 receives a packet coming from a device 121b in the local area network 120, said device 121b using an illicit IP address. In other words, the router 110 receives a packet, said packet comprising an illicit source IP address. Said IP address of the device 121b is not included in an address space of the router 110 and is therefore identified as illicit by the router 110. Furthermore, the router 110 may identify a physical address, referred to as an MAC (Media Access Control) address of the device 121b.

Optionally, in the context of the IPv6 protocol, the router 110, in a following step 202, performs a marking of the packet by associating a predefined mark with said packet. For this purpose, the firewall 112 of the router 110 implements a filtering rule that applies to each packet received coming from a device 121b using an illicit IP address. The filtering rule in question indicates performing an action of marking said packet with said predefined mark.

For example, in the context of the IPv6 protocol, such a rule implemented by a Linux operating system can be written: “ip6tables -A FORWARD -i br0 -j MARK—set-xmark 0x10000/0xffffffff”.

This rule defines the following elements:

-A FORWARD indicates adding a rule to the routing chain,

-i br0 specifies the interface 111 of the router on which the packet is received,

-j MARK indicates the action to be applied, in this case a marking with the predefined mark 0x10000, and

0xffffffff indicates that the predefined mark is applied in its entirety, without being altered. In a step 204, the router 110 generates, in the form of a packet, an error message marked with a predefined mark, i.e. with the mark predefined at the step 202. For example, in the context of the IPv6 protocol, the router 110 rejects the packet received at the step 200, or in other words deletes said received packet and, in response to the marking performed at the step 202, sends an error-message packet marked with the predefined mark to said device 121b using an illicit IP address. In other words, the error-message packet is generated with the same mark as that of the rejected packet.

For this purpose, the following rule can be applied:

“ip6tables -A FORWARD -p ipv6 -i br0 -j REJECT—reject-with icmp6-policy-fail”.

This rule defines the following elements:

-A FORWARD indicates adding a rule to the routing chain

-p ipv6 indicates that the rule applies to ipv6 protocol packets,

-i br0 specifies the interface 111 of the router and indicates that the rule applies to the packets that are received on said interface 111,

-j REJECT—reject-with icmp6-policy-fail indicates the action to be applied, in this case the rejection of the packet and the sending of an error-message packet in accordance with the error code icmp6-policy-fail, said error code defining a type of packet generated. Furthermore, the error-message packet being generated by a kernel of the operating system of the router 110, it may be necessary to activate a function of the kernel of the operating system to generate said error-message packet marked. In the case of the Linux operating system, the fwmark_reflect function may be used. It makes it possible to mark a response packet with the same mark as that used for marking the packet to which it is responding, i.e. the rejected packet.

In a step 206, the router 110 directs the marked response message to said device 121b using an illicit IP address. The routing module 113 of the router 110 implements the additional routing table comprising a single route that directs each packet by default to the first interface 111 of the router 110. The routing module 113 furthermore implements the second routing rule, which has priority with respect to the main routing rule defined previously in relation to FIG. 1, which applies said additional routing table to each packet marked with the predefined mark so that the main routing table is not applied to a packet marked with said predefined mark. Thus each packet marked with the predefined mark and not rejected and therefore not deleted by the firewall 112 (in particular the marked error-message packets) is sent to the local area network 120 intended for the device 121b identified by its MAC address. The device 121b is thus informed of its use of an illicit IP address. The additional routing table associated with the second routing tool furthermore makes it possible to avoid sending, to the wide area network 130, an error-message packet the destination of which is an illicit IP address, in other words an IP address not belonging to the local area network 120, and which would therefore be sent to the wide area network 130 with the main routing table. It should be noted that, when the error-message packet is received by the first interface 111 of the router 110, the interface 111 can identify the MAC address of the device 121b by means of a table associating an MAC address with an IP address, the IP address being able to be valid or invalid. Alternatively, the interface 111 can identify the MAC address of the device 121b by using an MAC-address resolution procedure.

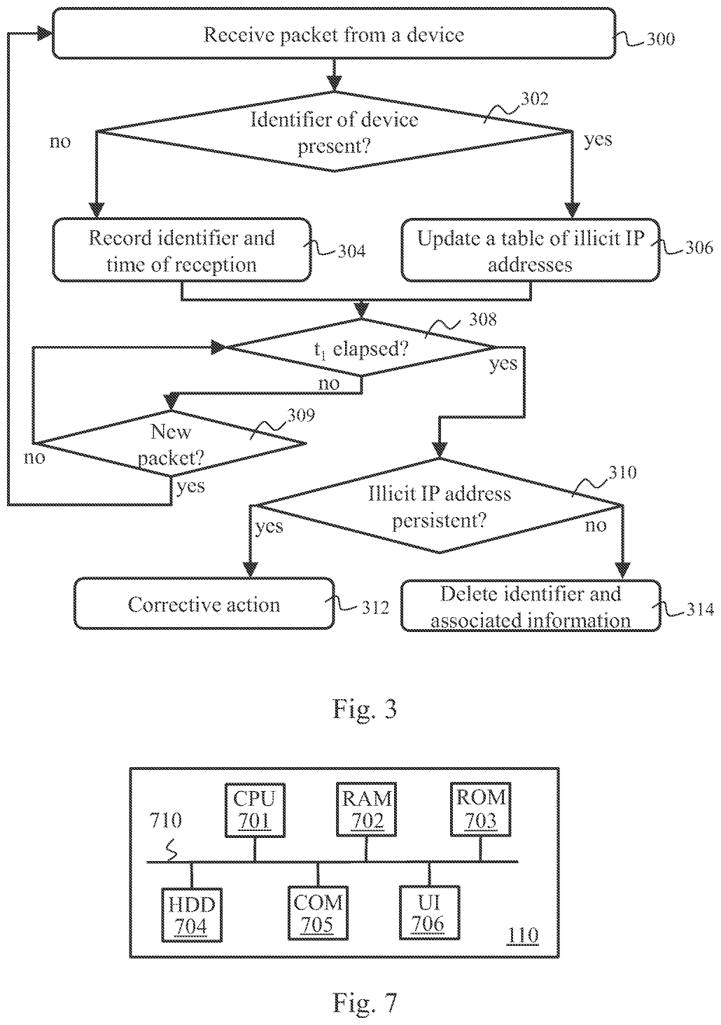

FIG. 3 illustrates schematically, according to one embodiment, a method for identifying a device 121 persisting in using an illicit IP address. The method for identifying a device 121 persisting in using an illicit IP address aims at counting packets coming from a device 121b using an illicit IP address over a predefined period in order to be able to determine whether said device 121b persists in using an illicit IP address over the course of time without managing itself to remedy the use of said illicit IP address.

In a step 300 identical to the step 200, the router 110 receives at a time t a packet coming from a device 121b, said device 121b using an illicit IP address. Said IP address of the device 121b is identified as illicit by the router 110. The router 110 identifies an identifier of the device 121b such as its MAC address. Furthermore, the router 110 uses a filtering rule that selects each packet of a device 121b using an illicit IP address and records a trace of the packet comprising the illicit IP address used by said device 121b and a time of reception of the packet.

In a step 302, the router 110 seeks in a table, referred to as a table of illicit IP addresses, the identifier (e.g. the MAC address) of the device 121b in question. If said identifier (e.g. said MAC address) of the device 121b is present in the table of illicit IP addresses, a step 306 is performed. Otherwise a step 304 is performed.

At the step 304, the router 110 records in the table of illicit IP addresses, an identifier, e.g. an MAC address, of the device 121b using an illicit IP address that sent the packet received at the step 300, The router 110 also recovers information on the recorded trace of said packet in order to record, in association with said identifier (e.g. said MAC address), optionally the illicit IP address used by the device 121b, a time of reception of said packet, referred to as the first reception time, as well as a first packet counter C1 and a second packet counter C2. The first counter C1 is initialised to a first initial value V1 and incremented by an incrementation value k making it possible to count the reception of the first packet, and the second packet counter C2 is initialised to a second initial value V2. For example, the first counter C1 and the second counter C2 are initialised to 0 (V1=V2=0) and the first counter C1 is furthermore incremented by 1 (k=1). A step 308 is next performed.

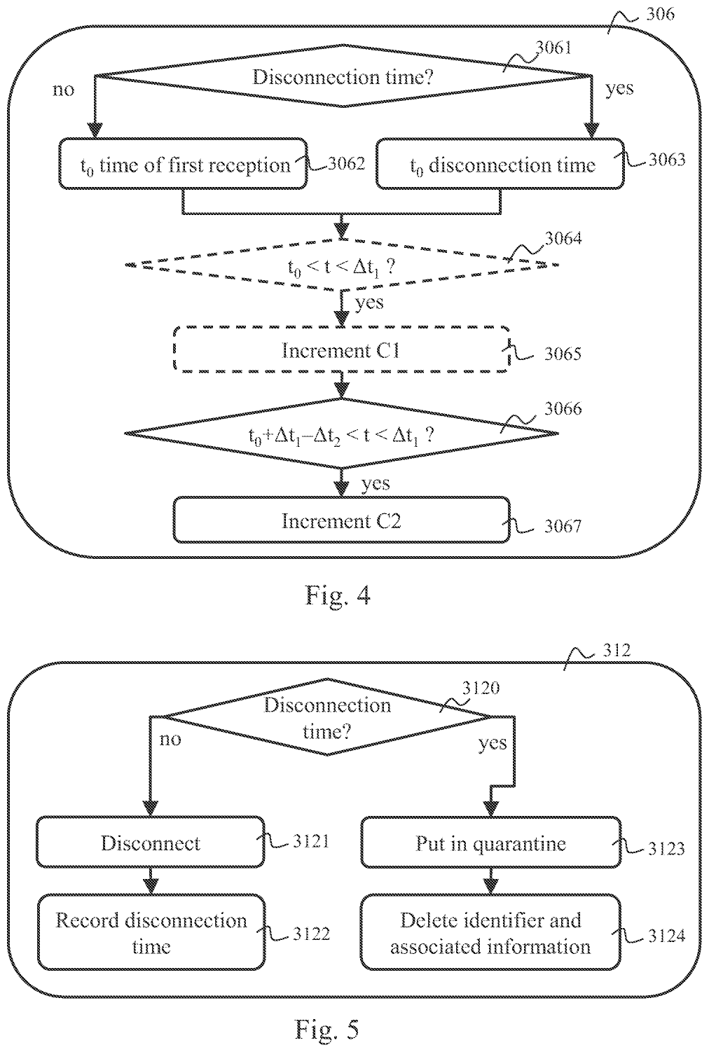

At the step 306, the router 110 updates the table of illicit IP addresses comprising the identifier (e.g. the MAC address) of the device 121b in question. For this purpose, the router 110 recovers information on the recorded trace of the packet and determines whether it is necessary to increment the counter C1 and/or the counter C2 according to the time of reception of the packet in accordance with an incrementation decision method described at FIG. 4. The first counter C1 is incremented if the packet is received during a first period of first predefined duration Δt₁ and the second counter C2 is incremented if the packet is received during a second period, of second predefined duration Δt₂ shorter than the first predefined duration Δt₁, and ending at the same time as the first period. The first predefined duration Δt₁ and the second predefined duration Δt₂ are sufficiently long and distant from each other to make it possible to identify whether or not a device 121b is persisting in using an illicit IP address. For example, the first predefined duration Δt₁ is of 120s and the second predefined duration Δt₂ is of 60s. The step 308 is next performed. At the step 308, the router 110 determines whether the first period of first predefined duration Δt₁ has elapsed. As soon as said first period has elapsed, a step 310 is performed. In the case where the first period of first duration Δt₁ has not elapsed, a step 309 is performed.

At the step 309, the router 110 waits until it receives any other packets coming from the device 121b. In the case of reception of a new packet containing the illicit IP address coming from the device 121b, the step 300 is repeated. Otherwise the step 308 is repeated. At the step 310, the router 110 determines whether the device 121b concerned is persisting in using an illicit IP address. If the first counter C1 and the second counter C2 are different respectively from the first initial value V1 and from the second initial value V2, then the device 121b is considered to be persisting in using an illicit IP address and a step 312 is performed. In the contrary case, in particular if the second counter C2 is equal to the second initial value V2, then the device 121b is not persisting in using an illicit IP address. The router 110 considers that the device 121b has itself remedied the use of an illicit IP address, for example by modifying its IP address, and a step 314 is performed.

At the step 312, the router 110 applies a corrective action in accordance with a correction method described at FIG. 5 in order to enable the device 121b to remedy the use of an illicit IP address. For example, one possible corrective action is disconnecting the device 121b in order to force it to reinitialise its network interface to reconnect to the local network 120. In this case, the time of disconnection of the device 121b is recorded in association with the identifier (e.g. the MAC address) of said device 121b and the first and second counters C1 and C2 are reinitialised.

At the step 314, the identifier (e.g. the MAC address) of the device 121b is deleted from the table of illicit IP addresses, as well as each item of information recorded in association with said identifier (e.g. said MAC address).

The counter C1 is an optional counter. In a variant embodiment, only the counter C2 is then used.

FIG. 4 illustrates schematically, according to one embodiment, the decision method for incrementation of the second counter C2 and optionally of the first counter C1 according to the time of reception of the packet from the device 121b concerned. Said incrementation decision method corresponds to the step 306 of FIG. 3.

In a first step 3061, the router 110 identifies whether a disconnection time is recorded in association with the identifier (e.g. the MAC address) of the device 121b concerned. The disconnection time corresponds to a time at which the device 121b was forcibly disconnected from the local area network 120. If no disconnection time is recorded, a step 3062 is performed. In the contrary case, a step 3063 is performed.

At the steps 3062 and 3063, the router 110 identifies a start time t0 as from which the first period and the second period are calculated.

At the step 3062, the start time t0 taken into account is the time of first reception, in other words the time at which the first packet from said device 121b was received, as described at the step 304 of FIG. 3. The first period is therefore a first time interval of first predefined duration Δt₁ that begins at the time of first reception. The second period is a second time interval lying between an instant t₀+Δt₁−Δt₂ and an instant t₀+Δt₁, the start time t0 being the time of first reception. Then a step 3064 is performed.

At the step 3063, the start time t0 taken into account is the time of disconnection of the device 121b. The first period is in this case a third time interval of first predefined duration Δt₁ and which begins at the time of disconnection. The second period is a fourth time interval lying between an instant t₀+Δt₁−Δt₂ and an instant t₀+Δt₁, the start time t0 being the time of disconnection. Then the step 3064 is performed.

At the optional step 3064, the router 110 determines whether the time t of reception of the packet lies in the first period. The router 110 for this purpose identifies whether the time t of reception of the packet occurs in a period of first duration Δt₁ counted as from the start time t0 identified at the step 3062 or at the step 3063. If such is the case, a step 3065 is performed.

At the optional step 3065, the first counter C1 is incremented by the incrementation value k, for example k=1.

In a step 3066, the router 110 determines whether the time of reception of the packet lies in the second period. The second period extends over a second predefined duration Δt₂, shorter than the first duration Δt₁, and commences at a time equal to t₀+Δt₁−Δt₂ so that the first period and the second period terminate at the same time. In other words, the router 110 determines whether the time t of reception of the packet lies between an instant t₀+Δt₁−Δt₂ and an instant t₀+Δt₁.

If such is the case, a step 3067 is performed.

At the step 3067, the second counter C2 is incremented by the incrementation value k.

FIG. 5 illustrates schematically, according to one embodiment, a method for correcting a use of an illicit IP address. The method for correcting an illicit IP address is implemented when a device 121b is considered to be persisting in using an illicit IP address. The method for correcting an illicit IP address aims at selecting and performing a corrective action in order to remedy the use of said illicit IP address. Said correction method corresponds to the step 312 of FIG. 3.

At the step 3120, the router 110 identifies whether a time of disconnection is recorded in association with the identifier (e.g. the MAC address) of the device 121b concerned. If such is the case, a step 3123 is performed. In the contrary case, if no time of disconnection is recorded, a step 3121 is performed.

At the step 3121, the router 110 disconnects the device 121b from the local area network 120 so as to force said device 121b to reinitialise its network interface. The router 110 determines a physical interface of said router 110 with which the MAC address of the device 121b is associated and then disconnects said physical interface. Once disconnected, the device 121b is forced to perform a reinitialisation of its network interface to be able to reconnect to the local area network 120. When it performs the reinitialisation of its network interface, the device 121b must send a new IP address request, said IP address then being attributed to it by the router 110 or by a DHCP server from the IP addresses that are available and valid.

For example, if the first interface 111 of the router 110 is a network bridge, the router 110 identifies the physical interface to which the device 121b is connected in a table associating, for a device 121, its MAC address with a physical interface to which the device 121 is connected. The router 110 next performs a reinitialisation of a physical port corresponding to said physical interface of the device 121b.

Alternatively, the router 110 interrogates a network peripheral such as a network switch or a Wi-Fi access point by sending the MAC address of the device 121b in order to identify whether the device 121b is connected to said network peripheral. If such is the case, the router 110 sends an instruction to disconnect said device 121b. According to a particular embodiment, the router 110 sends an instruction to disconnect the device 121b to each network peripheral and, when a network peripheral identifies a physical interface of said device 121b or a connection to said device 121b, said network peripheral implements the disconnection instruction. The router 110 communicates with the network peripheral by means of a peripheral driver installed in said router 110.

In the case where the network peripheral is a network switch, said network switch, on receiving the MAC address of the device 121b, seeks said MAC address in a table similar to that of a network bridge, associating, with each MAC address of a device 121, the physical interface of said device 121. The network switch next performs a reinitialisation of the physical port to which the device 121b is connected in order to disconnect the device 121b using an illicit IP address.

In the case where the network peripheral is a Wi-Fi access point, said Wi-Fi access point seeks the device 121b in a list of the MAC addresses of the devices 121 that are associated with it and, if the MAC address of said device 121b using an illicit IP address is identified, the Wi-Fi access point disconnects said MAC address.

In a following step 3122, the router 110 furthermore records, in association with the identifier (e.g. the MAC address) of the device 121b, the time of disconnection, in other words the time at which the device 121b was forcibly disconnected from the local network 120. Furthermore, the router 110 reinitialises the first packet counter C1 to V1 and the second packet counter C2 to V2.

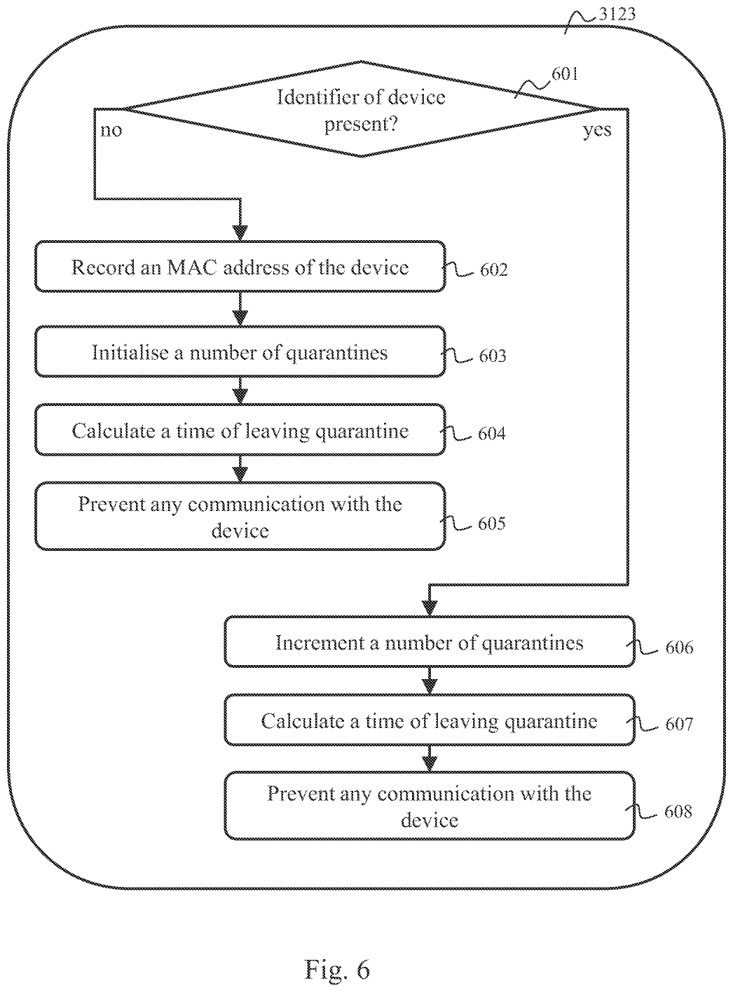

At the step 3123, the router 110 orders a quarantining of the device 120, in other words the router 110 prevents any communication with the local area network 120 during a quarantine period and in accordance with a quarantining method described below in relation to FIG. 6. The step 3124 is next performed.

At the step 3124, the identifier (e.g. the MAC address) of the device 121b is deleted from the table of illicit IP addresses, as well as each item of information recorded in association with said identifier. The step 3124 is identical to the step 314 of FIG. 3.

FIG. 6 illustrates schematically a quarantining method according to one embodiment. Said quarantining method corresponds to the step 3123 of FIG. 5 and is implemented in the method for signalling a use of an illicit IP address.

In a step 601, the router 110 seeks in a table, referred to as a quarantine table, the identifier (e.g. the MAC address) of the device 121b that is to be quarantined. If the identifier (e.g. the MAC address) of the device 121b is present in the quarantine table, a step 606 is performed. Otherwise a step 602 is performed.

At the step 602, the router 110 records, in the quarantine table, an identifier of the device, e.g. an MAC address of the device 121b that is to be quarantined.

At the step 603, the router 110 also records, in association with said identifier (e.g. said MAC address), a number n of quarantines initialised to one. According to one embodiment, the router 110 further records a time of quarantining, corresponding to an instant at which the router 110 orders the quarantining of the device 121b. Optionally, the illicit IP address is also recorded.

At the step 604, the router 110 calculates a time of leaving quarantine. The time of leaving quarantine is calculated by adding to the time of quarantining a predefined initial quarantine duration, e.g. 60 s.

In a step 605, the router 110 prevents any communication between the device 121b and the local area network 120. For this purpose, the router 110 identifies a physical interface to which the device 121b in question is connected and/or a network peripheral to which the device 121b is connected. The router 110 seeks for example the MAC address of said device 121b in a table of a network bridge associating with each MAC address of a device 121 the physical interface of said device 121 or interrogates a network peripheral that seeks said MAC address among the devices 121 that are connected to said peripheral and identifies the physical interface or the corresponding physical port. The router 110 next requests the network peripheral to which the device 121b is connected not to accept packets from said device 121b. For example, a network switch may ignore packets coming from an MAC address and not retransmit them, and this until the time of leaving quarantine. A Wi-Fi access point may define a list of MAC addresses prohibited association with said Wi-Fi access point and dissociate the device 121b so that said device 121b can no longer associate with the Wi-Fi access point until the time of leaving quarantine. In the case of a network peripheral that does not make it possible to ignore packets or to prohibit an association of a device 121b, the firewall 112 of the router 110 inserts a filtering rule for abandoning a packet coming from the MAC address of said device 121b before the filtering rule used for rejecting a packet from a device 121 using an illicit IP address. Thus a packet from the device 121b quarantined is rejected silently without generating an error message, which avoids encumbering the local area network 120.

At the step 606, the identifier (e.g. the MAC address) of the device 121b being already present in the quarantine table, the number n of quarantines is incremented. Furthermore, the time of quarantining is updated so as to correspond to an instant at which the router 110 orders the quarantining of the device 121b a further time.

In a step 607, a new time of leaving quarantine is calculated by adding to the time of quarantining a quarantining duration that depends on the number n of quarantines recorded.

For example, the quarantining duration may double whenever the device 121b is quarantined. The quarantine duration is thus equal to 2⁽ⁿ⁻¹⁾*Dt where n is the number of quarantines and Dt is the predefined initial quarantine duration. According to said example, if the predefined initial quarantine duration is 60 s, when the device 121b is quarantined for the second time the number n of quarantines is equal to 2 and the quarantine duration calculated is 120 s. When the device 121b is quarantined for the third time, the number n of quarantines is equal to 3 and the quarantine duration calculated is 240 s.

According to another example, the duration of the quarantine is proportional to the number n of quarantines and is thus equal to n*Dt where n is the number of quarantines and Dt is the predefined initial quarantine duration, e.g. equal to 60 s.

In a step 608, the router 110 prevents any communication between the device 121b and the local area network 120 in a similar manner to the step 605 and until the new time of leaving quarantine calculated at the step 607. As from the time of leaving quarantine, the router 110 once again enables communications between the device 121b and the local area network 120. A network switch then once again accepts packets coming from the MAC address of said device. A Wi-Fi access point can delete said MAC address from the list of MAC addresses prohibited association with said Wi-Fi access point. Alternatively, the router 110 deletes the filtering rule inserted at the moment of quarantining and having the action of abandoning a packet coming from the MAC address of said device 121b. Optionally, at the steps 605 and 608, an error notification is sent to an administrator of the local area network 120, for example by email or by means of a management console, so that said administrator of the local area network 120 can intervene when the device 121b using an illicit IP address restarts, in order once again to enable communications between the device 121b and the local area network 120 after the time of leaving quarantine.

FIG. 7 illustrates schematically the hardware architecture of the router 110 according to one embodiment. The router 110 then comprises, connected by a communication bus 710: a processor or CPU (central processing unit) 701; a random access memory RAM 702; a read only memory ROM 703; a storage unit 704, such as a hard disk HDD (hard disk drive), or a storage medium reader, such as an SD (Secure Digital) card reader; and an interface COM 705 for communicating with network peripherals.

The processor CPU 701 is capable of executing instructions loaded in the RAM 702 from the ROM 703, from an external memory (such as an SD card), from a storage medium, or from a communication network. When the router 110 is powered up, the processor CPU 701 is capable of reading instructions from the RAM 702 and executing them. These instructions form a computer program causing the implementation, by the processor CPU 701, of all or some of the steps described here in relation to the router 110. All or some of said steps can thus be implemented in software form by executing a set of instructions by a programmable machine, such as a DSP (digital signal processor) or a microcontroller, or be implemented in hardware form by a machine or a dedicated component, such as an FPGA (field-programmable gate array) or an ASIC (application specific integrated circuit).

1. A method for indicating a use of an illicit IP address in a local communication network, the local communication network being connected to another communication network by means of a router, wherein the method comprises the steps, performed by the router, of:
receiving a packet from at least one device belonging to the local communication network, said received packet comprising an illicit source IP address;
generating an error message packet and marking the error message packet with a predefined mark; and
returning the marked error message packet to the at least one device using an additional routing table redirecting each packet to the local communication network and a routing rule applying the additional routing table to each packet marked with the predefined mark.

2. The method according to claim 1, the method further comprising marking the packet received with the predefined mark and rejecting the packet received.

3. The method according to claim 1, the method further comprising:
recording in a table, referred to as an illicit IP address table, an identifier of the device using the illicit source IP address, in association with a received-packet counter initialised to an initial value, and in association with a time of reception of the received packet, referred to as a first reception time, if the identifier is absent from the table of illicit IP addresses;
updating the table of illicit IP addresses if the identifier of the device is present in the table of illicit IP addresses.

4. The method according to claim 3, wherein a first period being defined with a first predefined duration, the first period being counted as from the time of first reception, wherein a second period being defined with a second predefined duration, the second predefined duration being shorter than the first predefined duration and terminating at the same time as the first period, and wherein updating the table of illicit IP addresses comprises incrementing the received-packet counter for each packet received during the second period if a time of disconnection of the device is not given in the table of illicit IP addresses.

5. The method according to claim 3, wherein a first period being defined with a first predefined duration, the first period being counted as from a time of disconnection of said device, wherein a second period being defined with a second predefined duration, the second predefined duration being shorter than the first predefined duration and terminating at the same time as the first period, and wherein updating the table of illicit IP addresses comprises incrementing the received-packet counter for each packet received during the second period, if the time of disconnection of the device is given in the table of illicit IP addresses.

6. The method according to claim 4, further comprising the step of deleting the identifier from the table of illicit IP addresses in the case where the first period has elapsed and the received-packet counter is equal to the initial value.

7. The method according to claim 4, further comprising the step of forcing the device to reinitialise its network interface by disconnecting it from the local communication network, recording the time of disconnection in the table of illicit IP addresses and reinitialising the received-packet counter to the initial value, in the case where the first period has elapsed and the received-packet counter is different from the initial value.

8. The method according to claim 5, further comprising: preventing, during a configured quarantine duration, any communication with the device when the first period has elapsed, if a time of disconnection of a network interface of the device is given in the table, and if the received-packet counter is different from the initial value.

9. The method according to claim 8, wherein the configured quarantine duration increases at each new quarantine, a quarantine being a period during which any communication with the device prevented.

10. The method according to claim 9, wherein the quarantine duration is equal to n*Dt where n is a number of quarantines and Dt is an initial quarantine duration.

11. The method according to claim 9, wherein the quarantine duration is equal to 2⁽ⁿ⁻¹⁾*Dt where n is a number of quarantines and Dt is an initial quarantine duration.

12. The method according to claim 1, wherein the first communication network and the other communication network use the IPv6 communication protocol.

13. A router connecting a local communication network to another communication network, comprising:
means for receiving a packet from at least one device belonging to the local communication network, the received packet comprising an illicit source IP address;
means for generating an error message packet and for marking the error message packet with a predefined mark; and
means for returning the marked error message packet to the at least one device using an additional routing table redirecting each packet to the local communication network and a routing rule applying the additional routing table to each packet marked with the predefined mark.

14. A router according to claim 13, further comprising:
means for recording in a table, referred to as an illicit IP address table, an identifier of the device using the illicit source IP address; in association with a received-packet counter initialised to an initial value, and in association with a time of reception of the received packet, referred to as the time of first reception, if the identifier is absent from the table of illicit IP addresses,
means for updating the table of illicit IP addresses, if the identifier of the device is present in the table of illicit IP addresses.

15. The router according to claim 14, wherein the means for updating the table of illicit IP addresses comprise means for incrementing the received-packet counter for each packet received during a second period if a time of disconnection of the device is not given in the table of illicit IP addresses, a first period being defined with a first predefined duration, the first period being counted as from the time of first reception, the second period being defined with a second predefined duration, the second predefined duration being shorter than the first predefined duration and terminating at the same time as the first period.

16. The router according to claim 14, wherein the means for updating the table of illicit IP addresses comprise means for incrementing the received-packet counter for each packet received during a second period, if the time of disconnection of the device is given in the table of illicit IP addresses, a first period being defined with a first predefined duration, the first period being counted as from a time of disconnection of said device, the second period being defined with a second predefined duration, the second predefined duration being shorter than the first predefined duration and terminating at the same time as the first period.

17. The router according to claim 15, further comprising means for deleting the identifier from the table of illicit IP addresses in the case where the first period has elapsed and the received-packet counter is equal to the initial value.

18. The router according to claim 15, further comprising means for forcing the device to reinitialise its network interface by disconnecting it from the local communication network, recording the time of disconnection in the table of illicit IP addresses and reinitialising the received-packet counter to the initial value, in the case where the first period has elapsed and the received-packet counter is different from the initial value.

19. (canceled)

20. An information storage medium, stores a computer program comprising instructions for implementing, by a processor, the method according to claim 1, when the program is executed by the processor.
